(19) United States
(12) Patent Application Publication
(10) Pub. No.: US 2008/0076033 A1
(43) Pub. Date: Mar. 27, 2008

(54) HOLOGRAM RECORDING MATERIAL AND HOLOGRAM RECORDING MEDIUM

(75) Inventors: Naoki Hayashida, Tokyo (JP); Atsuko Kosuda, Tokyo (JP); Jiro Yoshinari, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK Corporation, Tokyo (JP)

(21) Appl. No.: 11/859,992

(22) Filed: Sep. 24, 2007

(30) Foreign Application Priority Data
Sep. 27, 2006 (JP) 2006-263414

(51) Int. Cl. G03C 1/73

(52) U.S. Cl. 430/2

(57) ABSTRACT

The present invention provides a hologram recording material which is suitable for volume hologram record and can attain high refractive index change, flexibility, high sensitivity, low scattering, environment resistance, durability, low dimensional change (low shrinkage) and high multiplicity in holographic memory record using not only a green laser but also a blue laser; and provides a hologram recording medium having a hologram recording layer comprising the hologram recording material. A hologram recording material comprising a metal oxide matrix and a photopolymerizable compound, wherein the metal oxide matrix comprises at least Si and Ti as metallic elements, and Ti originates from titanium-containing oxide fine particles. A hologram recording medium (11) having the hologram recording layer (21) comprising the hologram recording material.

### BACKGROUND OF THE INVENTION

1. Field of the Invention

The present invention relates to a hologram recording material suitable for volume hologram recording, and a hologram recording medium having a hologram recording layer comprising the hologram recording material. The invention relates in particular to a hologram recording material suitable for record and reproduction using not only a green laser light but also a blue laser light, and a hologram recording medium having a hologram recording layer comprising the hologram recording material.

2. Disclosure of the Related Art

Research and development of holographic memories have been advanced as large-capacity recording technique making high-speed transmission possible. O plus E, vol. 25, No. 4, 385-390 (2003) describes basic structures of holographic memories and a coming prospect thereof.

Examples of the property required for a hologram recording material include high refractive index change at the time of recording, high sensitivity, low scattering, environment resistance, durability, low dimensional change, and high multiplicity. About holographic memory record using a green laser, various reports have been made hitherto as follows.

As a hologram recording material, there is known a photopolymer material made mainly of an organic binder polymer and a photopolymerizable monomer. However, the photopolymer material has problems about environment resistance, durability and others. In order to solve the problems of the photopolymer material, attention has been paid to an organic-inorganic hybrid material made mainly of an inorganic matrix and a photopolymerizable monomer, and the hybrid material has been investigated. The inorganic matrix is excellent in environment resistance and durability.

For example, Japanese Patent No. 2953200 discloses a film for optical recording wherein a photopolymerizable monomer or oligomer and a photopolymerization initiator are contained in an inorganic substance network film. It is also disclosed that the brittleness of the inorganic network film is improved by modifying the inorganic network organically. However, the compatibility between the inorganic substance network and the photopolymerizable monomer or oligomer is bad. Therefore, a uniform film is not easily obtained. A specific disclosure of the publication is that a photosensitive layer having a thickness of about 10 μm (par. [0058]) is exposed to an argon laser having a wavelength of 514.5 nm (par. [0059]).

JP-A-11-344917 discloses an optical recording medium wherein an organic-inorganic hybrid matrix contains an optically active monomer. In the organic-inorganic hybrid matrix, a metal element has an alkyl group (a methyl group) or an aryl group (a phenyl group). However, the introduction of the methyl group makes it impossible to improve the compatibility between the hybrid matrix and the optically active monomer. The introduction of the phenyl group gives a more improvement in the compatibility than the introduction of the methyl group. However, the introduction of the phenyl group causes a fall in the curing speed of a hybrid matrix precursor ([0015] in the above publication). A specific disclosure of the publication is that record is made in a hologram recording layer having a thickness of 100 μm, using a YAG laser having a wavelength of 532 nm (Example, [0031]).

JP-A-2002-236439 discloses a hologram recording material comprising: a matrix made of an organic-inorganic hybrid polymer obtained by copolymerizing an organometallic compound containing an ethylenically unsaturated double bond and an organic monomer having an ethylenically unsaturated double bond, as main chain constituting components, and/or a hydrolyzed polycondensate thereof; a photopolymerizable compound; and a photopolymerization initiator. By the introduction of the large organic main chain component into the matrix material, the compatibility between the matrix and the photopolymerizable compound is improved. However, the introduction of the large organic main chain component permits the presence of a two-component structure of the organic main chain and an inorganic network in the matrix material. Thus, it appears that the matrix may not exhibit unified behavior at the time of recording so as to cause nonuniform recording. If the ratio of the organic main chain component in the matrix is large, the same problems as in the case of the above-mentioned photopolymer material, which uses an organic binder polymer, are caused. A specific disclosure of the publication is that a hologram recording material layer having a thickness of 20 μm (par. [0080]) is exposed to an argon laser having a wavelength of 514.5 nm (par. [0081]).

JP-A-2005-77740 discloses a hologram recording material comprising metal oxide particles, a polymerizable monomer and a photopolymerization initiator wherein the metal oxide particles are treated with a surface treating agent in which a hydrophobic group and a functional group which can undergo dehydration-condensation with a hydroxyl group on the surface of the metal oxide particles are bonded to a metal atom, and the metal atom is selected from the group consisting of titanium, aluminum, zirconium, and chromium. A specific disclosure of the publication is that record was made in a hologram recording layer having a thickness of 50 μm (par. [0086]), using a YAG laser having a wavelength of 532 nm in Example 1 (par. [0089]).

JP-A-2005-99612 discloses a hologram recording material comprising a compound having one or more polymerizable functional groups, a photopolymerization initiator, and colloidal silica particles. A specific disclosure of the publication is that record was made in a hologram recording layer having a thickness of 50 μm, using a Nd:YVO₄ laser having a wavelength of 532 nm (Example 1, par. [0036]).

In order to solve the problems of the hologram recording materials disclosed in the above-mentioned individual publications, JP-A-2005-321674 discloses a hologram recording material comprising: an organometallic compound at least containing at least two kinds of metals (Si and Ti), oxygen, and an aromatic group, and having an organometallic unit wherein two aromatic groups are directly bonded to one metal (Si); and a photopolymerizable compound. In Example 1 of the publication (in particular, pars. [0074] to [0078]), it is disclosed that a hologram recording medium which has a layer of the above-mentioned hologram recording material having a thickness of 100 μm gave a high transmittance, a high refractive index change, a low scattering, and a high multiplicity in record using a Nd:YAG laser (532 nm).

### SUMMARY OF THE INVENTION

Any of the above-mentioned publications disclose holographic memory record using a green laser, but do not disclose holographic memory record using a blue laser.

An object of the present invention is to provide a hologram recording material which is suitable for volume hologram record and can attain high refractive index change, flexibility, high sensitivity, low scattering, environment resistance, durability, low dimensional change (low shrinkage) and high multiplicity in holographic memory record using not only a green laser but also a blue laser; and to provide a hologram recording medium having a hologram recording layer comprising the hologram recording material.

The present inventors have made investigations, so as to find out that when a blue laser is used to make a holographic memory record in the hologram recording medium disclosed in JP-A-2005-321674, the light transmittance thereof falls so that good holographic memory recording characteristics cannot be obtained. When a light transmittance falls, holograms (interference fringes) are unevenly formed in the recording layer along the thickness direction of the recording layer so that scattering-based noises and the like are generated. It has been found out that in order to obtain good hologram image characteristics, it is necessary that the medium has a light transmittance of 50% or more.

A light transmittance of a hologram recording layer depends on a thickness thereof. As the thickness of the recording layer is made smaller, the light transmittance is improved; however, the widths of diffraction peaks obtained when reproducing light is irradiated into a recorded pattern become larger so that separability between adjacent diffraction peaks deteriorates. Accordingly, in order to obtain a sufficient SN ratio, it is indispensable to make a shift interval (an angle or the like) large when multiple record is made. For this reason, a high multiplicity cannot be attained. In the use of a hologram recording medium in any recording system, the thickness of its recording layer is required to be at lowest 100 μm in order to attain holographic memory recording characteristics for ensuring a high multiplicity.

The present inventors have made eager investigations, so as to understand that a fall in a light transmittance of a recording layer when a blue laser is used to make holographic memory record is caused by a matter that a constituting metallic element Ti is introduced into the matrix of metal oxide by hydrolysis and polymerization reaction (the so-called sol-gel reaction) of an alkoxide compound of Ti. The present inventors have then found out that even when a blue laser is used, the fall in a light transmittance is not generated by attaining the introduction of a constituting metallic element Ti into the matrix of metal oxide by use of bulk-form fine particles of titanium-containing oxide.

The present invention includes the followings:
(1) A hologram recording material comprising a metal oxide matrix and a photopolymerizable compound,

wherein the metal oxide matrix comprises at least Si and Ti as metallic elements, and Ti originates from titanium-containing oxide fine particles.

When the metallic element Ti is supplied to a system for preparing the metal oxide matrix, Ti is in the form of titanium-containing oxide fine particles.
(2) The hologram recording material according to the above-described (1), wherein Si in the metal oxide matrix originates from an alkoxide compound of Si.
(3) The hologram recording material according to the above-described (1) or (2), wherein the titanium-containing oxide fine particles have an average particle diameter of 1 to 50 nm.
(4) The hologram recording material according to any one of the above-described (1) to (3), further comprising a photopolymerization initiator.
(5) A hologram recording medium having a hologram recording layer comprising the hologram recording material according to any one of the above-described (1) to (4).
(6) The hologram recording medium according to the above-described (5), wherein the hologram recording layer has a thickness of at least 100 μm.
(7) The hologram recording medium according to the above-described (5) or (6), wherein record/reproduction of said hologram recording medium are made using a laser light having a wavelength of 350 to 450 nm.
(8) The hologram recording medium according to any one of the above-described (5) to (7), wherein said hologram recording medium has a light transmittance is 50% or more at a wavelength of 405 nm, or a light reflectance is 25% or more at a wavelength of 405 nm.
(9) A composition for preparing a hologram recording matrix material, comprising:

titanium-containing oxide fine particles; and

an alkoxide compound of silicon and/or a partially hydrolyzed condensate thereof.
(10) The composition for preparing a hologram recording matrix material according to the above-described (9), wherein the titanium-containing oxide fine particles are particles synthesized in the form of a bulk in advance.
(11) A process for producing a hologram recording material, comprising the steps of:

hydrolyzing an alkoxide compound of silicon,

incorporating titanium-containing oxide fine particles into the resultant system before, during or after the hydrolysis of the alkoxide compound of silicon, thereby yielding a precursor of a metal oxide matrix,

incorporating a photopolymerizable compound into the resultant system before, during or after the hydrolysis of the alkoxide compound of silicon; and

advancing a polycondensation reaction of the metal oxide precursor into which the photopolymerizable compound is incorporated.
(12) The process for producing a hologram recording material according to the above-described (11), wherein the titanium-containing oxide fine particles are synthesized in the form of a bulk in advance.
(13) A process for producing a hologram recording material, comprising the steps of:

subjecting an alkoxide compound of titanium to hydrolysis and polycondensation, thereby forming titanium oxide fine particles,

mixing the formed titanium oxide fine particles with an alkoxide compound of silicon to obtain a mixture,

hydrolyzing the alkoxide compound of silicon in the mixture, thereby yielding a precursor of a metal oxide matrix,

incorporating a photopolymerizable compound into the resultant system, after the step of forming the titanium oxide fine particles, and, before, during or after the hydrolysis of the alkoxide compound of silicon; and

advancing a polycondensation reaction of the metal oxide precursor into which the photopolymerizable compound is incorporated.

In the step of forming the titanium oxide fine particles, the alkoxide compound of silicon and the photopolymerizable compound are not present.
(14) The process for producing a hologram recording material according to the above-described (13), wherein the step of forming the titanium oxide fine particles is performed in an organic solvent which neither contains any cyclic ether skeleton nor any carbonyl oxygen.
(15) The process for producing a hologram recording material according to the above-described (14), wherein the organic solvent is selected from the group consisting of monoalcohols (such as methanol, ethanol, propanol, isopropanol, and butanol), dialcohols (such as ethylene glycol, and propylene glycol), monoalkyl ethers of dialcohols (such as 1-methoxy-2-propanol, and ethylene glycol monomethyl ether (i.e., methyl cellosolve)).

According to the hologram recording material of the present invention, the metal oxide matrix material contains Ti as a constituting element thereof. Thus, a high refractive index of the matrix material can be obtained. Additionally, the material does not absorb light in the blue wavelength region since Ti originates from titanium-containing oxide fine particles in a bulk form. Therefore, the hologram recording material of the present invention is used to provide a hologram recording medium giving good holographic memory recording characteristics such that the light transmittance does not lower in record and reproduction using a blue laser light as well as a green laser light while a high refractive index of the matrix material is maintained.

Furthermore, according to the present invention, titanium-containing oxide fine particles are used as the matrix of the recording material; therefore, a crosslinked structure formed between silicon oxide and the above-mentioned particles is attained so that the dynamic strength of the matrix is enhanced. As a result, it is possible to ensure a dynamic strength sufficient for offsetting the shrinkage stress when the organic monomer is polymerized. Thus, the hologram recording material of the present invention gives only a very small recording shrinkage ratio when record is made in the material.

### BRIEF DESCRIPTION OF THE DRAWINGS

FIG. 1 is a view illustrating a schematic cross section of a hologram recording medium produced in the example.

FIG. 2 is a plane view illustrating the outline of a hologram recording optical system used in the example.

### DETAILED DESCRIPTION OF THE INVENTION

The hologram recording material of the present invention is a composition comprising a metal oxide matrix and a photopolymerizable compound, wherein the metal oxide matrix contains at least Si and Ti as metallic elements, and Ti originates from titanium-containing oxide fine particles (i.e., titania fine particles or fine particles of complex oxide containing Ti). The metal oxide matrix may contain any optional metal other than Si and Ti. When the metal oxide matrix contains two or more of metals, the characteristics, such as the refractive index, are easily controlled. Thus, such a case is preferred for the design of the recording material.

Si in the metal oxide matrix is, in general, an element originating from an alkoxide compound of silicon. In other words, an alkoxide compound of silicon is subjected to hydrolysis and a polymerization reaction (the so-called sol-gel reaction), thereby converting the compound into a metal oxide form. The metal oxide matrix, which contains the titanium-containing oxide fine particles, is in a gel or sol form. In this manner, the metal oxide matrix functions as a matrix or a dispersing medium for the photopolymerizable compound in the hologram recording material layer. In other words, the photopolymerizable compound in a liquid phase is evenly dispersed with good compatibility in the metal oxide matrix in a gel- or a sol-form.

When light having coherency is irradiated onto the hologram recording material layer, the photopolymerizable organic compound (monomer) undergoes polymerization reaction in the exposed portion so as to be polymerized, and further the photopolymerizable organic compound diffuses and shifts from the unexposed portion into the exposed portion so that the polymerization of the exposed portion further advances. As a result, an area where the polymer produced from the photopolymerizable organic compound is large in amount and an area where the polymer is small in amount are formed in accordance with the intensity distribution of the light. At this time, the metal oxide shifts from the area where the polymer is large in amount to the area where the polymer is small in amount, so that the area where the polymer is large in amount becomes an area where the metal oxide is small in amount and the area where the polymer is small in amount becomes an area where the metal oxide is large in amount. In this way, the light exposure causes the formation of the area where the polymer is large in amount and the area where the metal oxide is large in amount. When a refractive index difference exists between the polymer and the metal oxide, a refractive index change is recorded in accordance with the light intensity distribution.

In order to obtain a better recording property in the hologram recording material, it is necessary that a difference is large between the refractive index of the polymer produced from the photopolymerizable compound and that of the metal oxide. The refractive indexes of the polymer and the metal oxide may be designed so as to make any one of the refractive indexes high (or low).

In the present invention, the metal oxide contains Ti as the essential constituent element thereof; therefore, a high refractive index of the metal oxide can be obtained. Accordingly, it is advisable to design the hologram recording material to cause the metal oxide to have a high refractive index and cause the polymer to have a low refractive index.

Ti is a preferred constituent element of the metal oxide from the viewpoint that Ti can realize a high refractive index. On the other hand, Ti has a drawback that Ti easily absorbs light having a wavelength in the blue wavelength region. Specifically, when the metal oxide absorbs light having a wavelength in the blue wavelength region, the light transmittance of a hologram recording medium using such a hologram recording material layer lowers in holographic memory record using a blue laser.

The present inventors have made eager investigations, so as to find out that when a metal oxide containing Si and Ti as constituting elements is synthesized by hydrolysis and polymerization reaction (the so-called sol-gel reaction) of the corresponding Si alkoxide compound and Ti alkoxide compound, a coordinating organic molecule (for example, an organic solvent containing a cyclic ether skeleton or carbonyl oxygen) is coordinated to the Ti atom or a Ti complex is formed between the Ti atom and the organic molecule so that the metal oxide absorbs blue light. In order to avoid the coordination of the coordinating organic molecule to the Ti atom or the formation of the Ti complex between the Ti atom and the organic molecule, titanium-containing oxide fine particles synthesized in a bulk form in advance are used in the present invention to introduce a constituting metallic element Ti into a metal oxide matrix.

Out of the constituting elements of the metal oxide, Si is introduced by hydrolysis and polymerization reaction of an alkoxide compound of silicon. Before, during or after the hydrolysis and polymerization reaction, bulk fine particles of a titanium-containing oxide are incorporated into the reaction system. According to the use of such bulk fine particles, even if an organic molecule is present in the hydrolysis and polymerization reaction system, the organic molecule is never coordinated to the Ti atom. Accordingly, the obtained metal oxide does not absorb light having a wavelength in the blue wavelength region. As described above, the metal oxide matrix is made to contain a silicon oxide resulting from hydrolysis and polymerization reaction of an alkoxide compound of silicon, and titanium-containing oxide fine particles synthesized in a bulk form in advance.

Furthermore, according to the use of the titanium-containing oxide fine particles in the matrix forming material, a structure in which the oxide fine particles are three-dimensionally crosslinked with a partial condensate (polymer) of the silicon oxide is attained, so that the dynamic strength of the matrix is enhanced. As a result, it is possible to ensure a dynamic strength sufficient for offsetting the shrinkage stress when the organic monomer is polymerized. Thus, the hologram recording material of the present invention gives only a very small recording shrinkage ratio when record is made in the material.

When the matrix is made only of Si alkoxide (and any other optional metal alkoxide), it is difficult to balance the dynamic strength of the matrix after reaction of the alkoxide(s) (i.e., after hydrolysis and polycondensation thereof) and the mobility of the organic monomer. In other words, it is necessary to make the dynamic strength of the matrix as high as possible in order to restrain shrinkage due to the polymerization of the organic monomer when light for record is exposed to the recording material. If diffusion of the individual components (i.e., the polymer produced by the polymerization of the monomer, and hydrolysis products) after the record advances gradually, storage stability of the recorded signals deteriorates. In order to restrain the diffusion of the individual components after the record, it is also necessary to make the dynamic strength of the matrix as high as possible. The restraint of the shrinkage in exposure to light for record or the restraint of the diffusion of the individual components after the record are more required than in record and reproduction using a blue laser light than in those using a green laser light.

In the meantime, in order to secure a sufficient modulation degree of recorded signals, it is indispensable that the organic monomer diffuses promptly to the portions exposed for the record and the organic monomer (or a polymer therefrom) has a sufficient concentration gradient between the exposed portions and the unexposed portions. A fall in the mobility of the organic monomer causes a fall in the recording sensitivity and the dynamic range. In order for the organic monomer to diffuse promptly (i.e., have a high mobility), it is necessary that the matrix has a somewhat porous structure, which is inconsistent with a request that the matrix should have a high strength. Such a problem can be solved by using titanium-containing oxide fine particles in the matrix forming material.

The titanium-containing oxide fine particles are selected from the group consisting of titania (TiO₂) fine particles, and fine complex oxide particles containing a titanium atom. The species of the complex oxide is not particularly limited, and examples thereof include TiMOx wherein M is Si, Fe, Sn, Sb, Zr or the like.

The titanium-containing oxide fine particles are preferably in the state of a colloid solution (sol) that contains colloidal particles having an average particle diameter of 1 to 50 nm. The species of the dispersing medium in the sol is not particularly limited, and preferred examples thereof include water, alcohol, ketone, ether, cyclic ether, ester, and halogenated hydrocarbon. The colloidal particles may be subjected to a surface treatment with a coupling agent, a surfactant or the like in advance. The shape of the colloidal particles may be selected at will as long as the shape does not give an adverse effect onto the optical transparency of the recording material. Specifically, the shape may be a completely spherical shape, a shape close thereto, a needle shape, or the so-called pearl necklace shape. If the average particle diameter of the titanium-containing oxide fine particles is larger than 50 nm, the particles cause light scattering easily. On the other hand, the fine particles having an average particle diameter of less than 1 nm are not easily produced. The average particle diameter of the titanium-containing oxide fine particles is more preferably 30 nm or less.

Specific examples of a commercially available product of the titanium-containing oxide fine particles include QUEEN TITANIC series (titania-based complex oxide sols wherein various organic dispersing media are used) manufactured by Catalyst & Chemicals Ind. Co., Ltd.

Various kinds of alkoxide compounds of silicon may be used. The alkoxide compounds of silicon is represented by, for example, the following general formula (I):

(R₁)mSi(OR₂)n (I)

wherein R₁ represents an alkyl or aryl group, R₂ represents an alkyl group, m represents 0, 1, 2 or 3, and n represents 1, 2, 3 or 4 provided that m+n is an atomic value of Si. R₁ may be different depending on m, and R₂ may be different depending on n.

The alkyl group represented by R₁ and R₂ is usually a lower alkyl group having about 1 to 4 carbon atoms. Examples thereof include methyl, ethyl, propyl, isopropyl, butyl, isobutyl, and sec-butyl groups. The aryl group represented by R₁ may be a phenyl group. The alkyl group and the aryl group may each have a substituent.

Specific examples of the alkoxide compound of Si include tetramethoxysilane, tetraethoxysilane, and tetrapropoxysilane, in each of which m=0 and n=4; and methyltrimethoxysilane, ethyltrimethoxysilane, propyltrimethoxysilane, methyltriethoxysilane, ethyltriethoxysialne, propyltriethoxysilane, γ-mercaptopropyltrimethoxysilane, γ-mercaptopropyltriethoxysilane, γ-aminopropyltrimethoxysilane, γ-aminopropyltriethoxysilane, phenyltrimethoxysilane, phenyltriethoxysilane, and phenyltripropoxysilane, in each of which m=1, and n=3.

Out of these silicon alkoxide compounds, preferred are, for example, tetramethoxysilane, tetraethoxysilane, methyltrimethoxysilane, ethyltrimethoxysilane, methyltriethoxysilane, and ethyltriethoxysilane.

For example, dimethyldimethoxysilane, dimethyldiethoxysilane, diphenyldimethoxysilane, and other silicon compounds wherein m=2 and n=2 may be used. When these silicon alkoxide compounds may be used if necessary, hardness, flexibility or some other property of the matrix after gelation can be adjusted.

When a monoalkoxysilane (m=3 and n=1), such as trimethylmethoxysilane, is present, the polymerization reaction is stopped. Accordingly, monoalkoxysilane can be used to adjust a molecular weight.

As the matrix forming material, an alkoxide compound of a metal atom M other than Si may be further used. Examples of the metal atom M include Ta, Al, Zr, Zn, In, and Sn.

A very small amount of an element other than the above-mentioned elements may be contained in the metal oxide.

A blend amount of the titanium-containing oxide fine particles is appropriately determined to give a desired refractive index, considering a blend ratio between Si and Ti in the metal oxide matrix. For example, it is advisable to set the ratio by mass of the silicon alkoxide compound to the titanium-containing oxide fine particles into the range of 0.1/1.0 to 10/1.0.

In the present invention, the photopolymerizable compound is a photopolymerizable monomer. As the photopolymerizable compound, a compound selected from a radical polymerizable compound and a cation polymerizable compound can be used.

The radical polymerizable compound is not particularly limited as long as the compound has in the molecule one or more radical polymerizable unsaturated double bonds. For example, a monofunctional and multifunctional compound having a (meth)acryloyl group or a vinyl group can be used. The wording “(meth)acryloyl group” is a wording for expressing a methacryloyl group and an acryloyl group collectively.

Examples of the compound having a (meth)acryloyl group, out of the radical polymerizable compounds, include monofunctional (meth)acrylates such as phenoxyethyl (meth)acrylate, 2-methoxyethyl(meth)acrylate, 2-hydroxyethyl(meth)acrylate, benzyl(meth)acrylate, cyclohexyl(meth)acrylate, ethoxydiethylene glycol(meth)acrylate, methoxypolyethylene glycol(meth)acrylate, methyl(meth)acrylate, polyethylene glycol(meth)acrylate, polypropylene glycol(meth)acrylate, and stearyl(meth)acrylate; and

polyfunctional(meth)acrylates such as trimethylolpropane tri(meth)acrylate, pentaerythritol tetra(meth)acrylate, dipentaerythritol hexa(meth)acrylate, diethylene glycol di(meth)acrylate, triethylene glycol di(meth)acrylate, tetraethylene glycol di(meth)acrylate, polyethylene glycol di(meth)acrylate, bis(2-hydroxyethyl)isocyanurate di(meth)acrylate, and 2,2-bis[4-(acryloxy-diethoxy)phenyl]propane. However, the compound having a (meth)acryloyl group is not necessarily limited thereto.

Examples of the compound having a vinyl group include monofunctional vinyl compounds such as monovinylbenzene, and ethylene glycol monovinyl ether; and polyfunctional vinyl compounds such as divinylbenzene, ethylene glycol divinyl ether, diethylene glycol divinyl ether, and triethylene glycol divinyl ether. However, the compound having a vinyl group is not necessarily limited thereto.

One kind of the radical polymerizable compound may be used, and two or more kinds thereof are used together. In the case of making the refractive index of the metal oxide high and making the refractive index of the organic polymer low, in the present invention, a compound having no aromatic group to have low refractive index (for example, refractive index of 1.5 or less) is preferred out of the above-mentioned radical polymerizable compounds. In order to make the compatibility with the metal oxide better, preferred is a more hydrophilic glycol derivative such as polyethylene glycol(meth)acrylate and polyethylene glycol di(meth)acrylate.

The cation polymerizable compound is not particularly limited about the structure as long as the compound has at least one reactive group selected from a cyclic ether group and a vinyl ether group.

Examples of the compound having a cyclic ether group out of such cation polymerizable compounds include compounds having an epoxy group, an alicyclic epoxy group or an oxetanyl group.

Specific examples of the compound having an epoxy group include monofunctional epoxy compounds such as 1,2-epoxyhexadecane, and 2-ethylhexyldiglycol glycidyl ether; and polyfunctional epoxy compounds such as bisphenol A diglycidyl ether, novolak type epoxy resins, trisphenolmethane triglycidyl ether, 1,4-butanediol diglycidyl ether, 1,6-hexanediol diglycidyl ether, glycerin triglycidyl ether, trimethylolpropane triglycidyl ether, propylene glycol diglycidyl ether, and polyethylene glycol diglycidyl ether.

Specific examples of the compound having an alicyclic epoxy group include monofunctional compounds such as 1,2-epoxy-4-vinylcyclohexane, D-2,2,6-trimethyl-2,3-epoxybicyclo[3,1,1]heptane, and 3,4-epoxycyclohexylmethyl(meth)acrylate; and polyfunctional compounds such as 2,4-epoxycyclohexylmethyl-3,4-epoxycyclohexane carboxylate, bis(3,4-epoxycyclohexylmethyl)adipate, 2-(3,4-epoxycyclohexyl-5,5-spiro-3,4-epoxy)cyclohexanone-m-dioxane, bis(2,3-epoxycyclopentyl)ether, and EHPE-3150 (alicyclic epoxy resin, manufactured by Dicel Chemical Industries, Ltd.).

Specific examples of the compound having an oxetanyl group include monofunctional oxetanyl compounds such as 3-ethyl-3-hydroxymethyloxetane, 3-ethyl-3-(2-ethylhexyloxymethyl)oxetane, and 3-ethyl-3-(cyclohexyloxymethyl)oxetane; and polyfunctional oxetanyl compounds such as 1,4-bis[(3-ethyl-3-oxetanylmethoxy)methyl]benzene, 1,3-bis[(3-ethyl-3-oxetanylmethoxy)methyl]propane, ethylene glycol bis(3-ethyl-3-oxetanylmethyl)ether, trimethylolpropanetris(3-ethyl-3-oxetanylmethyl)ether, pentaerythritol tetrakis(3-ethyl-3-oxetanylmethyl)ether, dipentaerythritol hexakis(3-ethyl-3-oxetanylmethyl)ether, and ethylene oxide modified bisphenol A bis(3-ethyl-3-oxetanylmethyl)ether.

Specific examples of the compound having a vinyl ether group, out of the above-mentioned cation polymerizable compounds, include monofunctional compounds such as triethylene glycol monovinyl ether, cyclohexanedimethanol monovinyl ether, and 4-hydroxycyclohexyl vinyl ether; and polyfunctional compounds such as triethylene glycol divinyl ether, tetraethylene glycol divinyl ether, trimethylolpropane trivinyl ether, cyclohexane-1,4-dimethylol divinyl ether, 1,4-butanediol divinyl ether, polyester divinyl ether, and polyurethane polyvinyl ether.

One kind of the cation polymerizable compound may be used, or two or more kinds thereof may be used together. As the photopolymerizable compound, an oligomer of the cation polymerizable compounds exemplified above may be used. In the case of making the refractive index of the metal oxide high and making the refractive index of the organic polymer low, in the present invention, a compound having no aromatic group to have low refractive index (for example, refractive index of 1.5 or less) is preferred out of the above-mentioned cation polymerizable compounds. In order to make the compatibility with the metal oxide better, preferred is a more hydrophilic glycol derivative such as polyethylene glycol diglycidyl ether.

It is advisable that in the present invention the photopolymerizable compound is used, for example, in an amount of about 5 to 1,000% by weight of total (as a nonvolatile component) of the metal oxide matrix, preferably in an amount of 10 to 300% by weight thereof. If the amount is less than 5% by weight, a large refractive index change is not easily obtained at the time of recording. If the amount is more than 1,000% by weight, a large refractive index change is not easily obtained, either, at the time of recording.

In the present invention, the hologram recording material further contains a photopolymerization initiator corresponding to the wavelength of recording light. When the photopolymerization initiator is contained in the hologram recording material, the polymerization of the photopolymerizable compound is promoted by the light exposure at the time of recording. Consequently, a higher sensitivity is achieved.

When a radical polymerizable compound is used as the photopolymerizable compound, a photo radical initiator is used. On the other hand, when a cation polymerizable compound is used as the photopolymerizable compound, a photo cation initiator is used.

Examples of the photo radical initiator include Darocure 1173, Irgacure 784, Irgacure 651, Irgacure 184 and Irgacure 907 (each manufactured by Ciba Specialty Chemicals Inc.). The content of the photo radical initiator is, for example, about 0.1 to 10% by weight, preferably about 0.5 to 5% by weight on the basis of the radical polymerizable compound.

As the photo cation initiator, for example, an onium salt such as a diazonium salt, a sulfonium salt, or a iodonium salt can be used. It is particularly preferred to use an aromatic onium salt. Besides, an iron-arene complex such as a ferrocene derivative, an arylsilanol-aluminum complex, or the like can be preferably used. It is advisable to select an appropriate initiator from these. Specific examples of the photo cation initiator include Cyracure UVI-6970, Cyracure UVI-6974 and Cyracure UVI-6990 (each manufactured by Dow Chemical Co. in USA), Irgacure 264 and Irgacure 250 (each manufactured by Ciba Specialty Chemicals Inc.), and CIT-1682 (manufactured by Nippon Soda Co., Ltd.). The content of the photo cation initiator is, for example, about 0.1 to 10% by weight, preferably about 0.5 to 5% by weight on the basis of the cation polymerizable compound.

The hologram recording material composition preferably contains a dye that functions as a photosensitizer corresponding to the wavelength of recording light or the like besides the photopolymerization initiator. Examples of the photosensitizer include thioxanthones such as thioxanthen-9-one, and 2,4-diethyl-9H-thioxanthen-9-one; xanthenes; cyanines; melocyanines; thiazines; acridines; anthraquinones; and squaliriums. It is advisable to set a amount to be used of the photosensitizer into the range of about 5 to about 50% by weight of the radical photoinitiator, for example, about 10% by weight thereof.

A process for producing the hologram recording material will be described in the following.

The metal oxide matrix is prepared by subjecting an alkoxide compound of silicon (and an alkoxide compound(s) of any other optional metal(s)) to hydrolysis and polymerization reaction, and incorporating a predetermined amount of bulk-form fine particles of a titanium-containing oxide into the resultant system before, during or after the hydrolysis polymerization reaction. When the metal element Ti is supplied to the system for preparing the metal oxide matrix, the metal element Ti is already in the form of titanium-containing oxide fine particles.

The hydrolysis and polymerization reaction of the alkoxide compound of silicon can be carried out by the same operation under the same conditions as in known sol-gel methods. For example, alkoxide compounds of the predetermined metals as starting materials are dissolved into an appropriate good solvent to prepare an homogeneous solution. An appropriate acid catalyst is dropwise added to the solution, and the solution is then stirred in the presence of water, whereby the reaction can be conducted.

Examples of such a solvent include: water; alcohols such as methanol, ethanol, propanol, isopropanol, and butanol; ethers such as diethyl ether, dioxane, dimethoxyethane and tetrahydrofuran; and N-methylpyrrolidone, acetonitrile, dimethylformamide, dimethylacetoamide, dimethylsulfoxide, acetone, benzene, and the like. The solvent may be appropriately selected from these. Alternatively, a mixture of these may be used. The amount of the solvent is not limited, and is preferably 10 to 1,000 parts by weight with respect to 100 parts by weight of the whole of the metal alkoxide compound.

Examples of the acid catalyst include: inorganic acids such as hydrochloric acid, sulfuric acid, nitric acid and phosphoric acid; organic acids such as formic acid, acetic acid, trichloroacetic acid, trifluoroacetic acid, propionic acid, methanesulfonic acid, ethanesulfonic acid, and p-toluenesulfonic acid; and the like.

The hydrolysis polymerization reaction can be generally conducted at room temperature, which depends on the reactivity of the metal alkoxide compounds. The reaction can be conducted at a temperature of about 0 to 150° C., preferably at a temperature of about room temperature to 50° C. The reaction time may be appropriately determined, correspondingly to the relationship with the reaction temperature. The time is about 0.1 to 240 hours. The reaction may be conducted in an inert atmosphere such as nitrogen gas, or may be conducted under a reduced pressure of about 0.5 to 1 atom while the alcohol produced by the polymerization reaction is removed.

Before, during or after the hydrolysis and polymerization reaction, a predetermined amount of titanium-containing oxide fine particles is incorporated into the reaction system. A crosslinking reaction and/or interactions such as hydrogen bonding are generated between hydrophilic groups, such as OH groups, present on the surface of the titanium-containing oxide fine particles and the above-mentioned partial condensate of Si.

Before, during or after the hydrolysis, the photopolymerizable organic compound is mixed. The photopolymerizable organic compound may be mixed with the metal alkoxide compounds as the starting materials after, during or before the hydrolysis. In the case of the mixing after the hydrolysis, it is preferred to add and mix the photopolymerizable organic compound in the state that the sol-gel reaction system containing the metal oxide and/or the metal oxide precursor is sol in order to perform the mixing uniformly. The mixing of a photopolymerization initiator or photosensitizer can also be conducted before, during or after the hydrolysis.

The polycondensation reaction of the metal oxide precursor, with which the photopolymerizable compound is mixed, is advanced to yield a hologram recording material wherein the photopolymerizable compound is uniformly incorporated in a uniform matrix composed of a sol-form silicon oxide originating from the silicon alkoxide compound, and the titanium-containing oxide fine particles. The hologram recording material is applied onto a substrate, and then drying of the solvent and a sol-gel reaction are advanced, thereby yielding a hologram recording material layer in a film form. In such a way, the hologram recording material layer is produced wherein the photopolymerizable compound is uniformly contained in a uniform matrix composed of the silicon oxide originating from the silicon alkoxide compound, and the titanium-containing oxide fine particles.

The hologram recording medium of the present invention comprises at least the above-mentioned hologram recording material layer. Usually, a hologram recording medium comprises a supporting substrate (i.e., a substrate) and a hologram recording material layer; however, a hologram recording medium may be made only of a hologram recording material layer without having any supporting substrate. For example, a medium composed only of a hologram recording material layer may be obtained by forming the hologram recording material layer onto the substrate by application, and then peeling the hologram recording material layer off from the substrate. In this case, the hologram recording material layer is, for example, a layer having a thickness in the order of millimeters.

The hologram recording medium of the present invention is suitable for record and reproduction using not only a green laser light but also a blue laser light having a wavelength of 350 to 450 nm. When the reproduction is made using transmitted light, the medium preferably has a light transmittance of 50% or more at a wavelength of 405 nm. When the reproduction is made using reflected light, the medium preferably has a light reflectance of 25% or more at a wavelength of 405 nm.

The hologram recording medium is either of a medium having a structure for performing reproduction using transmitted light (hereinafter referred to as a transmitted light reproducing type medium), and a medium having a structure for performing reproduction using reflected light (hereinafter referred to as a reflected light reproducing type medium) in accordance with an optical system used for the medium.

The transmitted light reproducing type medium is constructed in such a manner that a laser light for readout is irradiated into the medium, the laser light irradiated therein is diffracted by signals recorded in its hologram recording material layer, and the laser light transmitted through the medium is converted to electric signals by means of an image sensor. In other words, in the transmitted light reproducing type medium, the laser light to be detected is transmitted through the medium toward the medium side opposite to the medium side into which the reproducing laser light is irradiated. The transmitted light reproducing type medium usually has a structure wherein its recording material layer is sandwiched between two supporting substrates. In an optical system used for the medium, the image sensor, for detecting the transmitted laser light, is set up in the medium side opposite to the medium side into which the reproducing laser light emitted from a light source is irradiated.

Accordingly, in the transmitted light reproducing type medium, the supporting substrate, the recording material layer, and any other optional layer(s) are each made of a light-transmitting material. It is unallowable that any element blocking the transmission of the reproducing laser light is substantially present. The supporting substrate is usually a rigid substrate made of glass or resin.

In the meantime, the reflected light reproducing type medium is constructed in such a manner that a laser light for readout is irradiated into the medium, the laser light irradiated therein is diffracted by signals recorded in its hologram recording material layer, and then, the laser light is reflected on its reflective film, and the reflected laser light is converted to electric signals by means of an image sensor. In other words, in the reflected light reproducing type medium, the laser light to be detected is reflected toward the same medium side as the medium side into which the reproducing laser light is irradiated. The reflected light reproducing type medium usually has a structure wherein the recording material layer is formed on a supporting substrate positioned at the medium side into which the reproducing laser light is irradiated; and a reflective film and an another supporting substrate are formed on the recording material layer. In an optical system used for the medium, the image sensor, for detecting the reflected laser light, is set up in the same medium side as the medium side into which the reproducing laser light emitted from a light source is irradiated.

Accordingly, in the reflected light reproducing type medium, the supporting substrate positioned at the medium surface side into which the reproducing laser light is irradiated, the recording material layer, and other optional layer(s) positioned nearer to the medium side into which the reproducing laser light is irradiated than the reflective film are each made of a light-transmitting material. It is unallowable that these members each substantially contain an element blocking the incident or reflective reproducing laser light. The supporting substrate is usually a rigid substrate made of glass or resin. The supporting substrate positioned at the medium surface side into which the reproducing laser light is irradiated is required to have a light-transmitting property.

In any case of the transmitted light reproducing type medium and the reflected light reproducing type medium, it is important that the hologram recording material layer has a high light transmittance of, for example, 50% or more at a wavelength of 405 nm. For example, in the case of considering a layer (100 μm in thickness) composed only of the matrix material (metal oxide material), it is preferred that the layer has a high light transmittance of 90% or more at a wavelength of 405 nm.

The hologram recording material layer obtained as above-mentioned has a high transmittance to a blue laser. Therefore, even if a thickness of the recording material layer is set to 100 μm, a recording medium having a light transmittance of 50% or more, preferably 55% or more at a wavelength of 405 nm is obtained when the medium is a transmitted light reproducing type medium; or a recording medium having a light reflectance of 25% or more, preferably 27.5% or more at a wavelength of 405 nm is obtained when the medium is a reflected light reproducing type medium. In order to attain holographic memory recording characteristics such that a high multiplicity is ensured, necessary is a recording material layer having a thickness of 100 μm or more, preferably 200 μm or more. According to the present invention, however, even if the thickness of the recording material layer is set to, for example, 1 mm, it is possible to ensure a light transmittance of 50% or more at a wavelength of 405 nm (when the medium is a transmitted light reproducing type medium), or a light reflectance of 25% or more at a wavelength of 405 nm (when the medium is a reflected light reproducing type medium).

When the above described hologram recording material layer is used, a hologram recording medium having a recording layer thickness of 100 μm or more, which is suitable for data storage, can be obtained. The hologram recording medium can be produced by forming the hologram recording material in a film form onto a substrate, or sandwiching the hologram recording material in a film form between substrates.

In a transmitted light reproducing type medium, it is preferred to use, for the substrate(s), a material transparent to a recording/reproducing wavelength, such as glass or resin. It is preferred to form an anti-reflection film against the recording/reproducing wavelength for preventing noises or give address signals and so on, onto the substrate surface at the side opposite to the layer of the hologram recording material. In order to prevent interface reflection, which results in noises, it is preferred that the refractive index of the hologram recording material and that of the substrate are substantially equal to each other. It is allowable to form, between the hologram recording material layer and the substrate, a refractive index adjusting layer comprising a resin material or oil material having a refractive index substantially equal to that of the recording material or the substrate. In order to keep the thickness of the hologram recording material layer between the substrates, a spacer suitable for the thickness between the substrates may be arranged. End faces of the recording material medium are preferably subjected to treatment for sealing the recording material.

About the reflected light reproducing type medium, it is preferred that the substrate positioned at the medium surface side into which a reproducing laser light is irradiated is made of a material transparent to a recording and reproducing wavelength, such as glass or resin. As the substrate positioned at the medium surface side opposite to the medium surface side into which a reproducing laser light is irradiated, a substrate having thereon a reflective film is used. Specifically, a reflective film made of, for example, Al, Ag, Au or an alloy made mainly of these metals and the like is formed on a surface of a rigid substrate (which is not required to have a light-transmitting property), such as glass or resin, by vapor deposition, sputtering, ion plating, or any other film-forming method, whereby a substrate having thereon the reflective film is obtained. A hologram recording material layer is provided so as to have a predetermined thickness on the surface of the reflective film of this substrate, and further a light-transmitting substrate is caused to adhere onto the surface of this recording material layer. An adhesive layer, a flattening layer and the like may be provided between the hologram recording material layer and the reflective film, and/or between the hologram recording material layer and the light-transmitting substrate. It is also unallowable that these optional layers hinder the transmission of the laser light. Others than this matter are the same as in the above-mentioned transmitted light reproducing type medium.

The hologram recording medium having the hologram recording material of the present invention can be preferably used not only in a system wherein record and reproduction are made using a green laser light but also in a system wherein record and reproduction are made using a blue laser light having a wavelength of 350 to 450 nm.

### EXAMPLES

The present invention will be specifically described by way of the following examples; however, the invention is not limited to the examples.

### Example 1

Phenyltrimethoxysilane and titania sol were used to prepare a hologram recording material by a sol-gel method in accordance with the following steps:

### (Preparation of a Matrix Material)

To 7.8 g of phenyltrimethoxysilane was added 20 mL of isopropyl alcohol. Next, to the alkoxide solution was dropwise added a solution composed of 1.0 mL of water, 0.1 mL of a 1N aqueous solution of hydrochloric acid, and 2 mL of isopropyl alcohol at a room temperature while the alkoxide solution was stirred. Thereafter, the solution was refluxed for 1 hour while heated, thereby conducting a hydrolysis reaction.

The obtained solution was cooled to a room temperature, and then to this solution was added 40 g of a sol of TiO₂ (dispersed in isopropyl alcohol, manufactured by Catalysts & Chemicals Ind. Co., Ltd., concentration of nonvolatile components: 20.5% by weight). The mixture was further stirred at a room temperature for 1 hour. In this way, a sol solution was obtained wherein the ratio by mass of the silicon alkoxide compound/the titanium oxide fine particles was 0.95/1.0.

### (Photopolymerizable Compound)

To 100 parts by weight of polyethylene glycol diacrylate (M-245, manufactured by Toagosei Co., Ltd.) as a photopolymerizable compound were added 3 parts by weight of a photopolymerization initiator (IRG-907, manufactured by Ciba Specialty Chemicals K.K.) and 0.3 part by weight of thioxanthen-9-one as a photosensitizer to prepare a mixture containing the photopolymerizable compound.

### (Hologram Recording Material)

The sol solution and the mixture containing the photopolymerizable compound were mixed with each other at a room temperature to set the ratio of the matrix material (as a nonvolatile component) and that of the photopolymerizable compound to 67 parts by weight and 33 parts by weight, respectively, to obtain a hologram recording material solution substantially transparent and colorless.

The resultant hologram recording material solution was applied onto a glass substrate and then dried to prepare a recording medium sample, as will be detailed below.

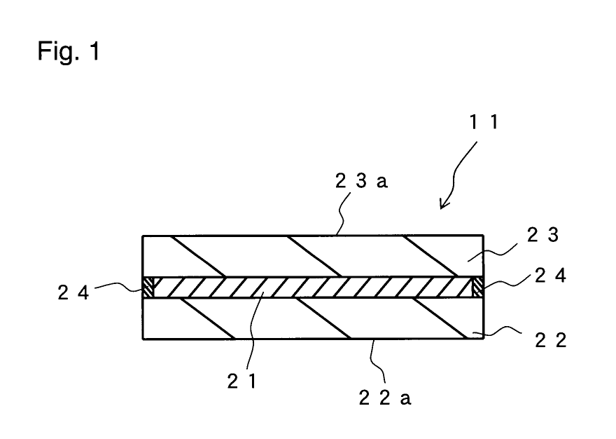

With reference to FIG. 1, which schematically illustrates a cross section of a hologram recording medium, explanation will be described.

A glass substrate (22) having a thickness of 1 mm and having one surface on which an anti-reflection film (22a) was formed was prepared. A spacer (24) having a predetermined thickness was put on a surface of the glass substrate (22) on which the anti-reflection film (22a) was not formed, and the hologram recording material solution obtained was applied onto the surface of the glass substrate (22). The resultant was dried at a room temperature for 1 hour, and then dried at 40° C. for 24 hours to volatilize the solvent. Through this drying step, the gelation (condensation reaction) of the metal oxide was advanced so as to yield a hologram recording material layer (21) having a dry film thickness of 400 μm wherein the metal oxide and the photopolymerizable compound were uniformly dispersed.

### (Hologram Recording Medium)

The hologram recording material layer (21) formed on the glass substrate (22) was covered with another glass substrate (23) having a thickness of 1 mm and having one surface on which an anti-reflection film (23a) was formed. At this time, the covering was carried out in such a manner that a surface of the glass substrate (23) on which the anti-reflection film (23a) was not formed would contact the surface of the hologram recording material layer (21). In this way, a hologram recording medium (11) was obtained which had a structure wherein the hologram recording material layer (21) was sandwiched between the two glass substrates (22) and (23).

### (Evaluation of Characteristics)

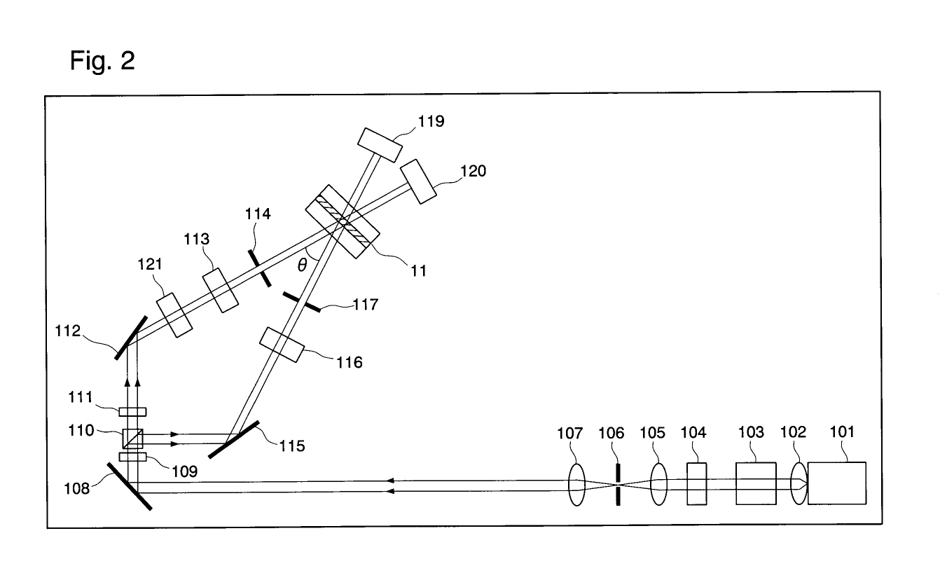

About the resultant hologram recording material sample, characteristics thereof were evaluated in a hologram recording optical system as illustrated in FIG. 2. The direction along which the paper surface on which FIG. 2 is drawn stretches is defined as a horizontal direction for convenience' sake.

In FIG. 2, the hologram recording medium sample (11) was set to make the recording material layer perpendicular to the horizontal direction.

In the hologram recording optical system illustrated in FIG. 2, a light source (101) for emitting a semiconductor laser (wavelength: 405 nm) in a single mode oscillation was used. Light emitted from this light source (101) was subjected to a spatial filtrating treatment by means of a beam rectifier (102), a light isolator (103), a shutter (104), a convex lens (105), a pinhole (106), and a convex lens (107), so as to be collimated, thereby enlarging the light into a beam diameter of about 10 mmφ. The enlarged beam was passed through a mirror (108) and a 1/2 wavelength plate (109) to take out 45° (45 degree) polarized light. The light was split into an S wave and a P wave (the ratio of S wave/P wave is 1/1) through a polarized beam splitter (110). The S wave obtained by the splitting was passed through a mirror (115), a polarizing filter (116), and an iris diaphragm (117) while a 1/2 wavelength plate (111) was used to convert the P wave obtained by the splitting to an S wave and then the S wave was passed through a mirror (112), a polarizing filter (113) and an iris diaphragm (114). In this way, the total incident angle θ of the two light fluxes irradiated into the hologram recording medium sample (11) was set to 37°, so as to record interference fringes of the two light fluxes in the sample (11).

The sample (11) was rotated in the horizontal direction to attain multiplexing (angle multiplexing; sample angle: −21° to +21°, angular interval: 3°) and further the sample (11) was rotated around an axis perpendicular to the surface of the sample 11 to attain multiplexing (peristrophic multiplexing; sample angle: 0 to 90°, angular interval: 10°), thereby recording a hologram. The multiplicity was 150. At the time of the recording, the sample was exposed to the light while the iris diaphragms (114) and (117) were each set into 4φ.

Details of this multiple recording will be described hereinafter. The sample (11) was rotated in the horizontal direction (around the axis perpendicular to the paper surface) from −21° to +21° at angular intervals of 3° to attain multiplexing. Thereafter, the sample (11) was rotated at 10° (i.e., 10° when it was viewed from the side into which the laser light was irradiated) around the axis perpendicular to the surface of the sample (11). The sample (11) was again rotated in the horizontal direction from −21° to +21° at angular intervals of 3° to attain multiplexing. This was repeated 10 times to rotate the sample (11) around the axis perpendicular to the surface of the sample (11) from 0° to 90°, thereby attaining multiple recording giving a multiplicity of 150.

A position where the angle of the surface of the sample (11) to a central line (not illustrated) for dividing the angle θ made by the two light fluxes into two equal parts was 90° was defined as a position where the angle in the horizontal rotation was ±0°. The axis perpendicular to the surface of the sample (11) is as follows: when the sample (11) is rectangular, the axis is a perpendicular axis passing at an intersection point of the two diagonal lines; and when the sample (11) is circular, the axis is a perpendicular axis passing at the center of the circle.

In order to react remaining unreacted components after the hologram recording, a sufficient quantity of light was irradiated by use of only one light fluxes. At the time of reproduction, with shading by the shutter (121), the iris diaphragm (117) was set into 3φ and only one light flux was irradiated. The sample (11) was continuously rotated into the horizontal direction from −23° to +23° and further rotated around the axis perpendicular to the surface of the sample (11) from 0° to 90° at angular intervals of 10°. In the individual angle positions, the diffraction efficiency was measured with a power meter (120). When a change in the volume (a recording shrinkage) or a change in the average refractive index of the recording material layer is not generated before and after the recording, the diffraction peak angle in the horizontal direction at the time of the recording is consistent with that at the time of the reproduction. Actually, however, a recording shrinkage or a change in the average refractive index is generated; therefore, the diffraction peak angle in the horizontal direction at the time of the reproduction is slightly different from the diffraction peak angle in the horizontal direction at the time of the recording. For this reason, at the time of the reproduction, the angle in the horizontal direction was continuously changed and then the diffraction efficiency was calculated from the peak intensity when a diffraction peak made its appearance. In FIG. 2, reference number (119) represents a power meter not used in this example.

At this time, a dynamic range M/# (the sum of the square roots of the diffraction efficiencies) was a high value of 17.8, which was a converted value corresponding to the case that the thickness of the hologram recording material layer was converted to 1 mm. A light transmittance of the medium (recording layer thickness: 400 μm) before the recording exposure to light (i.e., at the initial stage) was 83% at 405 nm. A fall in the light transmittance of the medium at 405 nm (i.e., the recording wavelength) after the recording was not observed.

At this time, a reduction ratio in the light transmittance on the basis of the glass substrates (22) and (23) each having the anti-reflection film was 0.6%. Specifically, with reference to FIG. 1, a laser light was irradiated into the sample (11) from the side of the substrate (22), so as to be transmitted toward the side of the substrate (23); in this case, 0.3% of the light was reflected on the interface between the air and the anti-reflection film (22a) by the presence of the anti-reflection film (22a), and 99.7% thereof was transmitted (absorption: 0%), and 0.3% of the transmitted light (that is, 99.7%) was reflected on the interface between the anti-reflection film (23a) of the substrate (23) and the air. As a result, 99.4% of the original laser light was transmitted.

The refractive index of the glass substrates (22) and (23) was substantially equal to that of the hologram recording material layer (21); therefore, reflection on the interface between the glass substrate (22) and the recording material layer (21) and reflection on the interface between the recording material layer (21) and the glass substrate (23) may be neglected.

### Comparative Example 1

In this Comparative Example, a Ti alkoxide compound (i.e., an oligomer of titanium butoxide represented by the following structural formula) was used instead of the titania sol in the matrix material.

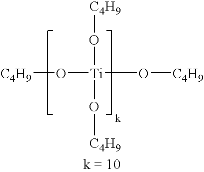

### (Synthesis of a Matrix Material)

In 40 mL of a tetrahydrofuran solvent, 7.8 g of diphenyldimethoxysilane and 7.2 g of the titanium butoxide oligomer (B-10, manufactured by Nippon Soda Co., Ltd.) were mixed with each other to prepare a metal alkoxide solution. Namely, the ratio by mole of Si/Ti was 1/1.

A solution composed of 2.1 mL of water, 0.3 mL of a 1 N aqueous solution of hydrochloric acid, and 5 mL of tetrahydrofuran was dropwise added to the metal alkoxide solution at a room temperature with stirring. The stirring was continued for 2 hours to conduct the hydrolysis reaction of the alkoxide. A sol solution was obtained in this manner.

Thereafter, in the same manner as in Example 1, a hologram recording material solution was prepared, and a hologram recording medium was produced.

About the resultant hologram recording medium sample, characteristics thereof were evaluated in the same manner as in Example 1. At this time, a dynamic range M/# was 8.7, which was a converted value corresponding to the case that the thickness of the hologram recording material layer was converted to 1 mm, and was a lower value than in Example 1.

A light transmittance of the medium (recording layer thickness: 400 μm) before the recording exposure to light (i.e., at the initial stage) was 43% at 405 nm, and was a lower light transmittance than in Example 1. After the recording, the light transmittance further lowered. When the exposed portions were observed with naked eyes after the recording, the transparency was declined, and the portions were clouded.

This is presumed as follows:

When the matrix material was prepared, the Ti alkoxide compound together with the Si alkoxide compound were used as starting materials to conduct a sol-gel reaction in the solvent of tetrahydrofuran; therefore, tetrahydrofuran was coordinated to the Ti atom so that a Ti complex absorbing blue light was formed. For this reason, the resultant metal oxide matrix was capable of absorbing blue light, and a light transmittance of the medium was lowered. It appears that because of a low light transmittance of the medium before the recording exposure to the light, heat at the time of the exposure accumulated easily in the medium so that the diffusion of the monomer and the polymerization reaction thereof advanced in a state that the temperature of the recording layer was raised. For this reason, it can be considered that the size of the monomer-polymerized phase and that of the matrix phase became giant with ease and phase separation between the matrix and the photopolymerizable compound occurs so that the light was scattered and the above-mentioned cloudiness was generated.

The above-mentioned example is about the transmitted light reproducing type medium having a light transmittance of 50% or more at a wavelength of 405 nm; however, it is evident that by use of a similar hologram recording material layer, a reflected light reproducing type medium having a light reflectance of 25% or more at a wavelength of 405 nm can be also produced.

What is claimed is:

1. A hologram recording material comprising a metal oxide matrix and a photopolymerizable compound,
wherein the metal oxide matrix comprises at least Si and Ti as metallic elements, and Ti originates from titanium-containing oxide fine particles.

2. The hologram recording material according to claim 1, wherein Si in the metal oxide matrix originates from an alkoxide compound of Si.

3. The hologram recording material according to claim 1, wherein the titanium-containing oxide fine particles have an average particle diameter of 1 to 50 nm.

4. The hologram recording material according to claim 1, further comprising a photopolymerization initiator.

5. A hologram recording medium having a hologram recording layer comprising the hologram recording material according to claim 1.

6. The hologram recording medium according to claim 5, wherein the hologram recording layer has a thickness of at least 100 μm.

7. The hologram recording medium according to claim 5, wherein record/reproduction of said hologram recording medium are made using a laser light having a wavelength of 350 to 450 nm.
